(19) United States
(12) Patent Application Publication
(10) Pub. No.: US 2025/0072431 A1
(43) Pub. Date: Mar. 6, 2025

(54) COMPOSITION FOR INHIBITING AFLATOXIN PRODUCTION AND ANTIMICROBIAL COMPOSITION

(71) Applicant: National Agriculture and Food Research Organization, Tsukuba-shi, Ibaraki (JP)

(72) Inventors: Masayo KUSHIRO, Tsukuba-shi, Ibaraki (JP); Tomohiro FURUKAWA, Shinagawa-ku, Tokyo (JP); Yoshiharu FUJII, Tsukuba-shi, Ibaraki (JP); Yohei HAREYAMA, Tokorozawa-shi, Saitama (JP)

(73) Assignee: National Agriculture and Food Research Organization, Tsukuba-shi, Ibaraki (JP)

(21) Appl. No.: 18/718,048

(22) PCT Filed: Sep. 7, 2022
(86) PCT No.: PCT/JP2022/033552

§ 371 Date: Jun. 9, 2024

(30) Foreign Application Priority Data
Dec. 10, 2021 (JP) 2021-200968

(51) Int. Cl. A01N 65/08; A01N 65/06; A01N 65/16; A01N 65/28; A01N 65/40; A01P 3/00

(52) U.S. Cl. CPC A01N 65/08; A01N 65/06; A01N 65/16; A01N 65/28; A01N 65/40; A01P 3/00

(57) ABSTRACT

A composition for inhibiting aflatoxin production or an antimicrobial composition against an aflatoxin-producing fungus, each containing a plant-derived component. The composition for inhibiting aflatoxin production by an aflatoxin-producing fungus of the present invention contains at least one selected from the group consisting of Gordonia axillaris extract, garden huckleberry extract, Wallum Banksia extract, and Welwitschia mirabilis extract. The antimicrobial composition against an aflatoxin-producing fungus of the present invention contains at least one selected from the group consisting of Gordonia axillaris extract, garden huckleberry extract, and Wallum Banksia extract.

### CROSS-REFERENCE TO RELATED APPLICATIONS

This application is a U.S. National Stage Application pursuant to 35 U.S.C. § 371 of International Patent Application PCT/JP2022/033552, filed on Sep. 7, 2022, and published as WO 2023/105867 on Jun. 15, 2023, which claims priority to Japanese Patent Application No. 2021-200968, filed on Dec. 10, 2021, all of which are incorporated herein by reference in their entireties for all purposes.

### TECHNICAL FIELD

The present invention relates to a composition for inhibiting aflatoxin production and an antimicrobial composition against an aflatoxin-producing fungus and particularly relates to the compositions that contain a specific plant extract.

### BACKGROUND ART

Aflatoxins are mycotoxins having strong toxicities including carcinogenicity. The contamination of agricultural crops including grains due to aflatoxins has been a major problem worldwide, and economic loss due to disposal of contaminated foods and contaminated feeds is also huge. Since the contaminations of aflatoxins are originated from aflatoxin-producing fungi normally present in soils of farm fields and the like, development of a technology of controlling these fungi has been demanded. Patent Literature 1 states that a specific compound can be used for inhibiting an aflatoxin production and controlling contaminations of aflatoxins, and Non Patent Literature 1 also states that another compound has an antimicrobial action against aflatoxin-producing fungi and aflatoxin production inhibiting action.

On the other hand, Non Patent Literature 2 states that an extract of Gordonia axillaris has an antioxidant action. Non Patent Literature 3 states that a methanol extract of a stem or root of Welwitschia mirabilis contains resveratrol and the like. However, Non Patent Literatures 2 and 3 do not state an antimicrobial action against aflatoxin-producing fungi, or an aflatoxin production inhibiting action. In addition, Non Patent Literature 4 states that an essential oil extracted from leaves of Myrtus communis through steam distillation has an antimicrobial action but does not state an alcohol extract of Myrtus communis.

### CITATION LIST

### Patent Literature

Patent Literature 1: Japanese Patent Application Publication No. 2019-94261

### Non Patent Literatures

Non Patent Literature 1: JSM Mycotoxins (2019), 69 (2), 81-83
Non Patent Literature 2: Molecules (2010), 15, 8602-8617
Non Patent Literature 3: Chemistry & Biodiversity (2005), 2 (6), 773-779
Non Patent Literature 4: Phytomedicine (2010), 17, 771-774

### SUMMARY OF INVENTION

### Problems to be Solved by the Invention

Although various fungicides have been used as post-harvest agricultural chemicals, their persistence and toxicity have been problems, and materials having a higher safety have been demanded. In view of this, an object of the present invention is to provide a composition for inhibiting aflatoxin production or an antimicrobial composition against an aflatoxin-producing fungus, comprising a plant-derived component.

### Means for Solution of the Problems

As a result of conducting earnest studies in order to solve the above problems, the present inventors have found that a specific plant extract exhibits an aflatoxin production inhibiting action or an antimicrobial action against an aflatoxin-producing fungus, and have completed the present invention. Specifically, the present invention provides a composition for inhibiting aflatoxin production, an antimicrobial composition against an aflatoxin-producing fungus, and a method for inhibiting production of aflatoxins or inhibiting proliferation of an aflatoxin-producing fungus, as described below.
[1] A composition for inhibiting aflatoxin production of an aflatoxin-producing fungus, comprising at least one selected from the group consisting of a Gordonia axillaris extract, a garden huckleberry extract, a Wallum Banksia extract, and a Welwitschia mirabilis extract.
[2] An antimicrobial composition against an aflatoxin-producing fungus, comprising at least one selected from the group consisting of a Gordonia axillaris extract, a garden huckleberry extract, and a Wallum Banksia extract.
[3] The composition according to the above [1] or [2], wherein the extract is an alcohol extract.
[4] A composition for inhibiting aflatoxin production of an aflatoxin-producing fungus, comprising a Myrtus communis extract, wherein the Myrtus communis extract is an alcohol extract.
[5] An antimicrobial composition against an aflatoxin-producing fungus, comprising a Myrtus communis extract, wherein the Myrtus communis extract is an alcohol extract.
[6] The composition according to any one of the above [1] to [5], wherein the aflatoxin-producing fungus is a fungus of Aspergillus.
[7] The composition according to any one of the above [1] to [6], wherein a content of the extract is 0.01 to 20% by mass in terms of dry mass of a raw material plant, relative to a total mass of the composition.
[8] A method for inhibiting production of aflatoxins, comprising a step of applying at least one selected from the group consisting of a Gordonia axillaris extract, a garden huckleberry extract, a Wallum Banksia extract, and a Welwitschia mirabilis extract to an aflatoxin-producing fungus.
[9] A method for inhibiting proliferation of an aflatoxin-producing fungus, comprising a step of applying at least one selected from the group consisting of a Gordonia axillaris extract, a garden huckleberry extract, and a Wallum Banksia extract to the fungus.
[10] A method for inhibiting production of aflatoxins, comprising a step of applying a Myrtus communis extract to an aflatoxin-producing fungus, wherein the Myrtus communis extract is an alcohol extract.
[11] A method for inhibiting proliferation of an aflatoxin-producing fungus, comprising a step of applying a Myrtus communis extract to the aflatoxin-producing fungus, wherein the Myrtus communis extract is an alcohol extract.

### Advantageous Effects of Invention

According to the present invention, it is possible to inhibit production of aflatoxins by using a Gordonia axillaris extract, a garden huckleberry extract, a Wallum Banksia extract, a Welwitschia mirabilis extract, or a Myrtus communis extract and inhibit proliferation of an aflatoxin-producing fungus by using a Gordonia axillaris extract, a garden huckleberry extract, a Wallum Banksia extract, or a Myrtus communis extract. Since these plant extracts have lower concerns about persistence or toxicity than general fungicides, it becomes possible to provide a material having a higher safety.

### DESCRIPTION OF EMBODIMENTS

The present invention will be described in further detail below.

The present invention relates to a composition for inhibiting aflatoxin production of an aflatoxin-producing fungus, and comprises an extract of Gordonia axillaris, garden huckleberry, Wallum Banksia, Welwitschia mirabilis, or Myrtus communis. There is no report that any of these plants has toxicity to humans. In addition, the present invention also relates to an antimicrobial composition against an aflatoxin-producing fungus, and comprises an extract of Gordonia axillaris, garden huckleberry, Wallum Banksia, or Myrtus communis.

Gordonia axillaris is an evergreen tree of Theaceae, leaves or stems of which may be used as a raw material of the above-described extract. Garden huckleberry (Solanum nigrum L. var. guineense L.) is a fruit tree, leaves or stems of which may be used as a raw material of the above-described extract. Wallum banksia (Banksia aemula) is an evergreen tree, leaves or stems of which may be used as a raw material of the above-described extract. Welwitschia mirabilis is a gymnosperm, leaves and the like of which may be used as a raw material of the above-described extract. Myrtus communis is an evergreen shrub, leaves or stems of which may be used as a raw material of the above-described extract.

As a method for preparing the above-described extract, a method that is normally used in the art can be used without particular limitation. For example, leaves or the entire aboveground parts of a plant of interest may be pulverized and stirred with an extraction solvent added thereto to prepare an extract (extract liquid) of the plant. This extract liquid may be dried and solidified at, for example, about 35 to about 45° C. with an inert gas sprayed to the extract liquid to prepare an extract in a dried and solidified form.

The extraction solvent is not particularly limited and may be, for example, an alcohol such as methanol, ethanol, 1-propanol, or 2-propanol or an organic solvent such as acetone, or may be hot water. In a certain aspect, the above extract may be an alcohol extract or a hot water extract.

The content of the extract is not particularly limited and may be, for example, about 0.01 to about 20% by mass, and preferably about 0.1 to about 10% by mass in terms of dry mass of a raw material plant, relative to the total mass of the composition of the present invention. The expression “in terms of dry mass of a raw material plant” in the present Specification refers to a mass obtained by converting the mass of the extract to a dry mass of the raw material plant.

“Aflatoxins” described in the present Specification are kinds of mycotoxins, and types such as B1, B2, G1, and G2 are known. It is also known that these aflatoxins are biosynthesized in a common pathway. In addition, it is also known that fungi of Aspergillus include fungi that produce the aflatoxins, that is, “aflatoxin-producing fungi”. Fungi of Aspergillus that are the aflatoxin-producing fungus include, for example, A. flavus, A. parasiticus, A. nomius, A. pseudotamarii, A. bombycis, and A. parvisclerotigenus.

The composition of the present invention may further contain any solvent and/or additive which is used normally in the art as long as the object of the present invention is not impaired, and may further contain another component which is effective for inhibiting aflatoxin production or for being anti-bacterial against an aflatoxin-producing fungus.

As the solvent, any solvent which is used normally in the art can be employed without limitation, and the solvent may be, for example, water, a buffer solution, or an alcohol such as methanol, ethanol, 1-propanol, or 2-propanol, or a mixture of these.

The composition of the present invention can be applied and used in a location where an aflatoxin-producing fungus has been grown or a location where an aflatoxin-producing fungus is suspected to have been grown. A specific subject to be applied to is not particularly limited and may be, for example, seeds, plants, harvested agricultural crops, farm fields, and the like.

As another aspect, the present invention also relates to a method for inhibiting production of aflatoxins, which includes a step of applying an extract of Gordonia axillaris, garden huckleberry, Wallum Banksia, Welwitschia mirabilis, or, Myrtus communis to an aflatoxin-producing fungus. In addition, the present invention also relates to a method for inhibiting proliferation of an aflatoxin-producing fungus, which includes a step of applying an extract of Gordonia axillaris, garden huckleberry, Wallum Banksia, or, Myrtus communis to an aflatoxin-producing fungus. The extract is as described above in terms of the composition of the present invention, and can be used in the methods of the present invention in the form of that composition.

Hereinafter, the present invention will be described in detail by using Examples, but the scope of the present invention is not limited to these Examples.

### EXAMPLES

### Preparation Examples

Various plants were collected and dried at 60° C. for 24 hours. Specifically, Rumex japonicus and Oenothera rosea were collected in the site of the Institution of Food Research of the National Agriculture and Food Research Organization and the other plants were collected in the Tsukuba Botanical Garden.

Leaves of the dried plants were finely pulverized by using a waring blender. However, the plant of Spiranthes sinensis was small, and the entire aboveground parts thereof was pulverized all together. 2 g of a pulverized product thus prepared was taken into a 50-mL tube, and 10 mL of 99.5% ethanol was added, followed by stirring for 1 minute. Then, the resultant was treated with ultrasonic waves for 3 minutes and left stand for 24 hours at room temperature to prepare an extract liquid. This was centrifuged at 4400 rpm for 5 minutes to collect a supernatant, 1 mL of which was taken into a 5-mL test tube and was dried and solidified at 40° C. while a nitrogen gas was sprayed thereto to prepare a plant extract in a dried and solidified form. This plant extract was dissolved again in 100 μL of 99.5% ethanol and used in the following tests.

### Test Example 1

A spore suspension of Aspergillus flavus MAFF 111229 strain was used, and the fungus was cultured by a TIP method in accordance with the description of Non Patent Literature 1 (if necessary, see Document 5 cited in Non Patent Literature 1). As a medium, a YES liquid medium (yeast extract 2 g/100 mL, sucrose 20 g/100 mL) was used, and 244 μL of the medium was added for each one of 1-mL sterile chips packed with quartz wool, and 5 μL of the spore suspension and 1 μL of the plant extract (ethanol solution) obtained by dissolving again were added. The final concentration of each plant extract was 8 mg/mL (about 1% by mass) in terms of dry mass of a raw material plant. To Control, ethanol was added instead of the plant extract liquid. After the culturing, the concentration of aflatoxin B₁ (AFB₁) in the medium was quantified by a conventional method, the weight (wet weight) of the bacterial cells pooled on the chip was measured, and a relative value (%) to the value of Control was calculated. Note that the concentration of AFB₁ was quantified by adding trifluoroacetic acid to the above medium and detecting hemiacetal AFB2a to which AFB₁ was converted, by HPLC. Results are shown in Table 1.

TABLE 1
AFB₁ production inhibiting action and proliferation
inhibiting action by a plant extract

| | Relative value of | Relative value of |
|---|---|---|
| Plant | AFB₁ (%) | fungus weight (%) |
| Myrtus communis | 0.2 ± 0.3 | 66.4 ± 4.4 |
| Wallum Banksia | 0.5 ± 0.3 | 60.5 ± 15.7 |
| garden huckleberry | 3.0 ± 5.0 | 57.7 ± 37.7 |
| Welwitschia mirabilis | 4.7 ± 1.3 | 71.0 ± 4.6 |
| Gordonia axillaris | 6.9 ± 9.5 | 76.6 ± 17.3 |
| Spondias cytherea | 13.2 ± 9.4 | 85.0 ± 1.5 |
| Podocarpus totara | 17.3 ± 7.4 | 106.5 ± 20.3 |
| Melaleuca decora | 15.2 ± 8.5 | 84.8 ± 9.0 |
| Oenothera rosea | 23.4 ± 3.4 | 82.9 ± 22.4 |
| Melaleuca leucadendra | 28.1 ± 5.9 | 89.3 ± 2.3 |
| Lantana montevidensis | 32.0 ± 4.3 | 83.7 ± 12.2 |
| Quercus dentata | 41.8 ± 7.2 | 90.7 ± 2.6 |
| Ponderosa lemon | 50.1 ± 19.2 | 92.2 ± 2.7 |
| Rumex japonicus | 50.7 ± 19.6 | 95.5 ± 10.2 |
| Vitex agnus-castus | 52.3 ± 4.6 | 85.5 ± 8.1 |
| Camellia cuspidata | 53.4 ± 35.2 | 83.4 ± 15.4 |
| Saururus chinensis | 58.1 ± 18.6 | 92.8 ± 8.5 |

Among the plant extracts used in the test, the Myrtus communis extract, the Wallum Banksia extract, the garden huckleberry extract, the Welwitschia mirabilis extract, and the Gordonia axillaris extract significantly inhibited the production of AFB₁ by A. flavus and also inhibited the proliferation of A. flavus (Table 1). In particular, the actions of inhibiting the production of AFB₁ by these extracts were relatively higher than the actions of inhibiting the proliferation of A. flavus. That is, the above extracts acted more specifically on the production of aflatoxins than the proliferation of A. flavus. It is expected that drug-resistant bacteria are unlikely to be generated in components having low influences on the growth of A. flavus.

Note that although resveratrol is contained in the Welwitschia mirabilis extract (Non Patent Literature 3), the concentration of resveratrol in the plant extract liquid used in the test was 3.3 μg/mL at most as estimated through comparison (the height of the peak) with data of the standard substance based on the chromatogram of HPLC. It is considered to be unlikely that resveratrol of such a low concentration inhibits the production of AFB₁ by A. flavus or the proliferation of A. flavus, and as a result of the HPLC analysis, a large number of components which brought about higher peaks were detected. For this reason, it can be considered that any or a combination of these components contributed to the inhibition of the production of AFB₁ by A. flavus or the proliferation of A. flavus.

### Test Example 2

A. parasiticus was cultured in a medium containing a Wallum Banksia extract, a Welwitschia mirabilis extract, a Gordonia axillaris extract, or ethanol (Control) in the same manner as in Test Example 1 except that A. parasiticus NRRL 2999 strain was used in place of the A. flavus MAFF 111229 strain. The concentrations of various aflatoxins in the culture solutions were quantified by a conventional method (fluorescent detection with HPLC after derivatization with trifluoroacetic acid), and the weight (wet weight) of the bacterial cells pooled on the chip was measured, and a relative value (%) to the value of Control was calculated. Results are shown in Tables 2 and 3.

TABLE 2
Aflatoxin production inhibiting action by a plant extract

| | Relative value (%) of aflatoxin | | | |
|---|---|---|---|---|
| Plant | AFB₁ | AFB₂ | AFG₁ | AFG₂ |
| Wallum | 2.40 ± 2.3 | 8.66 ± 7.5 | 1.81 ± 2.0 | 2.58 ± 1.5 |
| Banksia | | | | |
| Welwitschia | 35.4 ± 3.8 | 33.7 ± 6.0 | 14.1 ± 3.2 | 13.8 ± 3.8 |
| mirabilis | | | | |
| Gordonia | 0.503 ± 0.023 | 6.88 ± 0.073 | 0.172 ± 0.011 | 1.52 ± 0.050 |
| axillaris | | | | |

TABLE 3
Proliferation inhibiting action by a plant extract

| Plant | Relative value (%) of fungus weight |
|---|---|
| Wallum banksia | 79.3 ± 6.2 |
| Welwitschia mirabilis | 111 ± 0.78 |
| Gordonia axillaris | 70.9 ± 4.7 |

Plant extracts which inhibited the production of AFB₁ by A. flavus also inhibited the production of various aflatoxins by A. parasiticus (Table 2). The proliferation of A. parasiticus was not inhibited by the Welwitschia mirabilis extract but was inhibited by the Wallum Banksia extract or the Gordonia axillaris extract (Table 3).

As described above, it was found that the production of aflatoxins can be inhibited by the Gordonia axillaris extract, the garden huckleberry extract, the Wallum Banksia extract, the Welwitschia mirabilis extract, or the Myrtus communis extract and the proliferation of an aflatoxin-producing fungus can be inhibited by the Gordonia axillaris extract, the garden huckleberry extract, the Wallum Banksia extract, or the Myrtus communis extract. Therefore, it becomes possible to provide a material having a higher safety that is a plant extract with lower concerns about persistence or toxicity than general fungicides.

1.-7. (canceled)

8. A method for inhibiting production of aflatoxins, comprising a step of:
applying at least one selected from the group consisting of a Gordonia axillaris extract, a garden huckleberry extract, a Wallum Banksia extract, and a Welwitschia mirabilis extract to an aflatoxin-producing fungus; or
applying a Myrtus communis extract to an aflatoxin-producing fungus, wherein the Myrtus communis extract is an alcohol extract.

9. A method for inhibiting proliferation of an aflatoxin-producing fungus, comprising a step of:
applying at least one selected from the group consisting of a Gordonia axillaris extract, a garden huckleberry extract, and a Wallum Banksia extract to the fungus; or
applying a Myrtus communis extract to the aflatoxin-producing fungus, wherein the Myrtus communis extract is an alcohol extract.

10.-11. (canceled)

12. The method according to claim 8, wherein at least one selected from the group consisting of a Gordonia axillaris extract, a garden huckleberry extract, a Wallum Banksia extract, and a Welwitschia mirabilis extract is applied to the aflatoxin-producing fungus.

13. The method according to claim 12, wherein said at least one selected from the group consisting of a Gordonia axillaris extract, a garden huckleberry extract, a Wallum Banksia extract, and a Welwitschia mirabilis extract is an alcohol extract.

14. The method according to claim 8, wherein the aflatoxin-producing fungus is a fungus of Aspergillus.

15. The method according to claim 9, wherein at least one selected from the group consisting of a Gordonia axillaris extract, a garden huckleberry extract, and a Wallum Banksia extract is applied to the aflatoxin-producing fungus.

16. The method according to claim 15, wherein said at least one selected from the group consisting of a Gordonia axillaris extract, a garden huckleberry extract, and a Wallum Banksia extract is an alcohol extract.

17. The method according to claim 9, wherein the aflatoxin-producing fungus is a fungus of Aspergillus.
